(19) United States
(12) Patent Application Publication
(10) Pub. No.: US 2019/0105841 A1
(43) Pub. Date: Apr. 11, 2019

(54) MEASURE OF THE BUILD MATERIAL IN A BUILD MATERIAL CONTAINER

(71) Applicant: HEWLETT-PACKARD DEVELOPMENT COMPANY, L.P., Houston, TX (US)

(72) Inventors: Juan Manuel ZAMORANO, Sant Cugat del Valles - Barcelona (ES); David SORIANO FOSAS, Sant Cugat del Valles - Barcelona (ES); Sergio DE SANTIAGO DOMINQUEZ, Sant Cugat del Valles - Barcelona (ES)

(73) Assignee: HEWLETT-PACKARD DEVELOPMENT COMPANY, L.P., Houston, TX (US)

(21) Appl. No.: 16/089,078

(22) PCT Filed: Oct. 25, 2016
(86) PCT No.: PCT/US2016/058687

§ 371 Date: Sep. 27, 2018

(51) Int. Cl. B29C 64/386; B33Y 30/00; B33Y 50/00; B29C 64/255; B22F 3/00; G01F 23/22

(52) U.S. Cl. CPC B29C 64/386; B33Y 30/00; B33Y 50/00; B28B 1/001; B22F 3/008; G01F 23/226; B29C 64/255

(57) ABSTRACT

An example method for measuring the amount of build material in a build material container of a 3D printer may comprise mounting a belt element tensioned between at least two shafts, and attaching a body to the belt element; driving the body towards a surface of the build material while measuring the advance and the speed of the belt element; detecting a reduction of the speed of the belt element, and determining that the body has then contacted the surface of the build material; and determining the position of the surface of the build material based at least on the measured advance of the belt element.

### BACKGROUND

Some tri-dimensional (3D) printing apparatus comprise a build material container, which may be loaded with an amount of build material, such as build powder. To generate a 3D object, build material from the build material container may be spread in successive layers on a build platform, where each layer may be selectively solidified to generate the 3D object layer by layer.

### BRIEF DESCRIPTION

Some non-limiting examples of the present disclosure will be described in the following with reference to the appended drawings, in which:

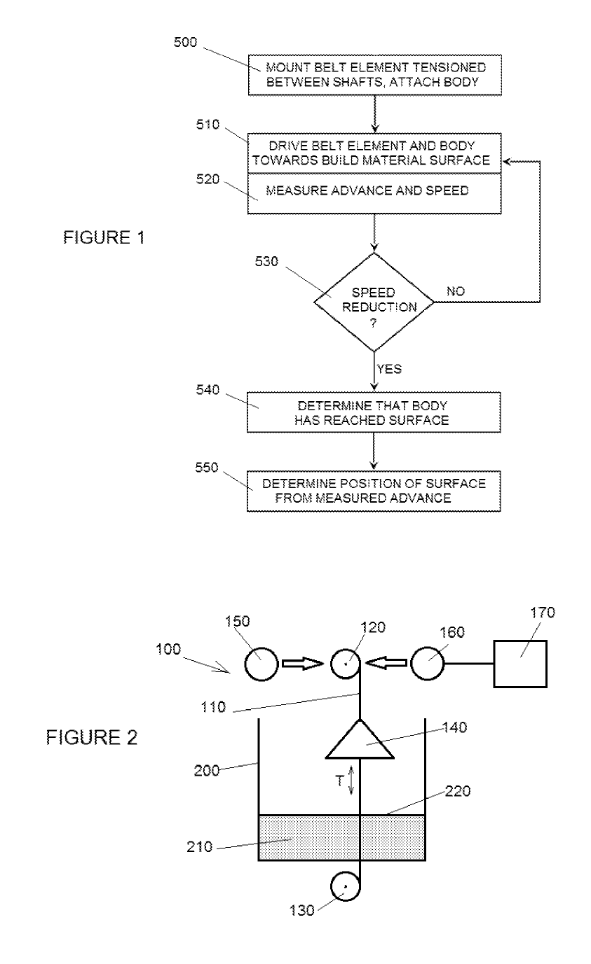

FIG. 1 is a flowchart illustrating examples of a method for measuring the amount of build material in a build material container of a 3D printer according to examples disclosed herein;

FIG. 2 is a schematic diagram illustrating examples of systems for measuring the amount of build material in a build material container of a 3D printing apparatus, according to implementations disclosed herein;

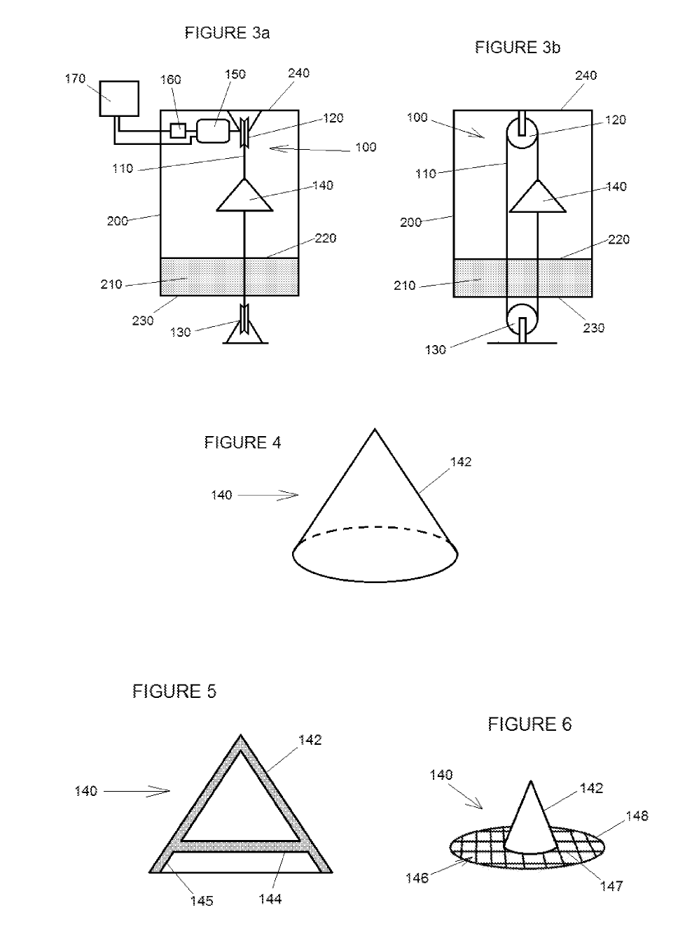

FIGS. 3a and 3b are schematic diagrams illustrating, in front and side elevation view, examples of systems for measuring the amount of build material as disclosed herein;

FIGS. 4, 5 and 6 are schematic views illustrating example shapes of a body that may be used in implementations of systems for measuring the amount of build material according to the present disclosure;

FIG. 7 is a schematic diagram illustrating examples of build material containers of a 3D printing apparatus, according to implementations disclosed herein;

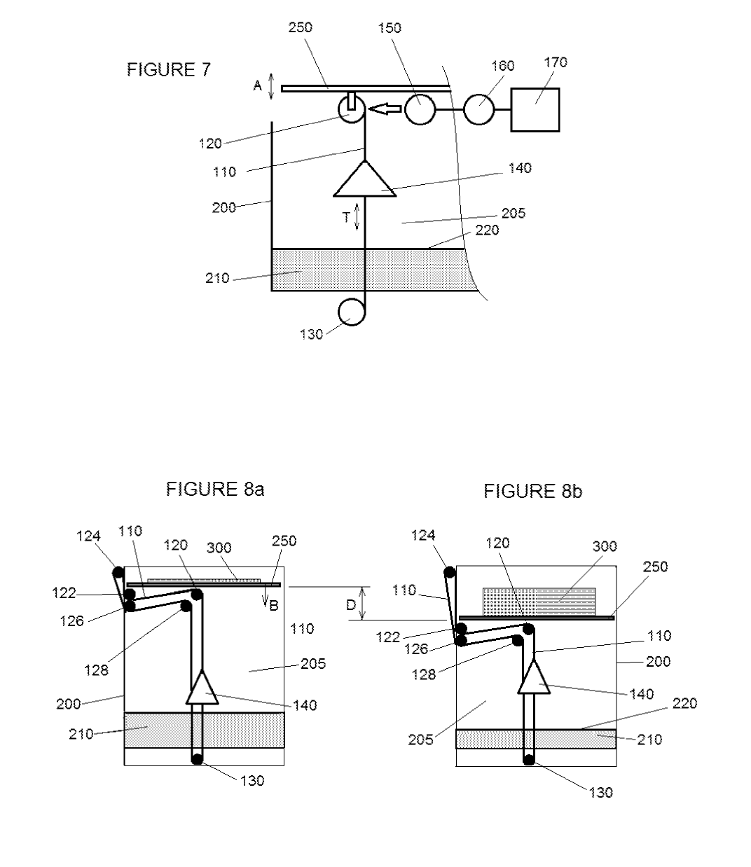

FIGS. 8a and 8b are schematic views illustrating examples of build material containers of a 3D printing apparatus, in two different positions during operation;

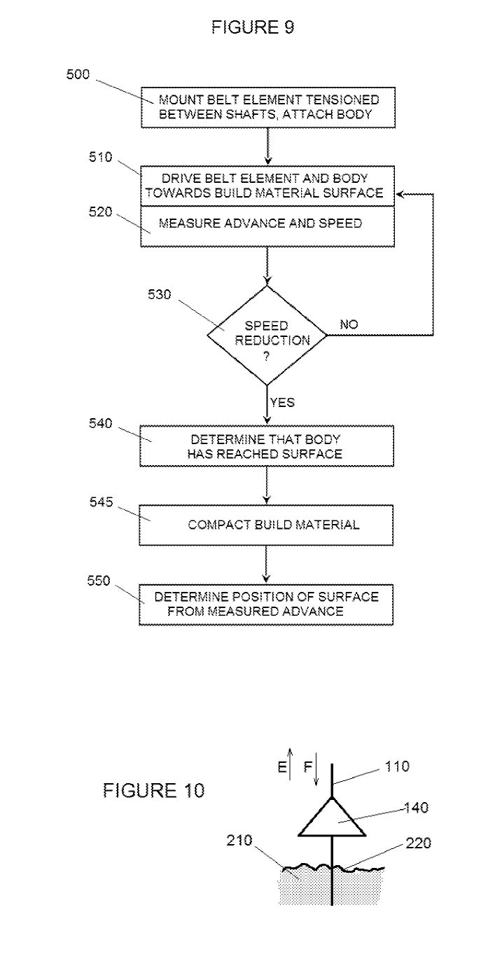

FIG. 9 is a flowchart illustrating examples of a method for measuring the amount of build material according to examples disclosed herein; and

FIG. 10 is a schematic view of a detail of an example system for measuring the amount of build material, employed in an implementation of a method as disclosed in FIG. 9.

### DETAILED DESCRIPTION

Some 3D printing systems use build material that have a powdered, or granular, form. According to one example a suitable build material may be a powdered semi-crystalline thermoplastic material. One suitable material may be Nylon 12, which is available, for example, from Sigma-Aldrich Co. LLC. Another suitable material may be PA 2200 which is available from Electro Optical Systems EOS GmbH.

In other examples other suitable build materials may be used. Such materials may include, for example, powdered metal materials, powdered plastics materials, powdered composite materials, powdered ceramic materials, powdered glass materials, powdered resin material, powdered polymer materials, and the like.

In some implementations other suitable build materials may be used, such as for example fluid or viscous build materials.

A build material container for 3D printing apparatus may be provided on a trolley or building unit, which may also comprise the build platform, for example at the top of the build material container. The build material container may be loaded with a build material, such as a build powder, and the trolley or building unit may then be docked in a 3D printing apparatus for manufacturing 3D objects.

However, in other implementations, the build material container may be incorporated in the 3D printing apparatus as a part that is not intended to be separated from the apparatus.

In some implementations, a movable build platform on which the 3D objects are generated in successive layers may be placed above the build material in the build material container, and may be lowered after each layer, such that the space or volume available for the build material in the build material container may be variable.

During different stages of operation of the 3D printing apparatus it may be convenient to measure the amount of build material in the build material container.

For example, manufactured 3D objects may have better quality if there are no interruptions during the process. In order to estimate if an object may be manufactured without interruptions, it may be useful to know the amount of build material remaining in the build material container before starting the generation of the object. If the remaining amount is not sufficient, a warning to refill the build material container may be issued.

The measure of the amount of build material in the build material container has to be made in an environment with dust, noise and the risk of electrostatic discharges, and taking into account that build material distribution inside the container may be irregular: build material may for example form irregular shapes and cavities, the surface of the build material may not be even and may not be settled. Furthermore, some build material may become attached to the walls or to other surfaces of the build material container.

Furthermore, the build material container may be mounted on a movable trolley or building unit, and/or the space for the build material may be variable due to the movement of the build platform, as discussed above.

FIG. 1 illustrates implementations of a method for measuring the amount of build material, such as build powder, in a build material container of a 3D printer as disclosed herein. Implementations of the method may comprise, at 500, mounting a belt element tensioned between at least two shafts, and attaching a body to the belt element.

At 510 the belt element, and the body attached to the belt element, may be driven towards a surface of the build material, while measuring at 520 the advance and the speed of the belt element.

The speed of the belt element may be monitored at 530 to detect a speed reduction: in case of a positive detection, it may be determined at 540 that the body has contacted the surface of the build material, since the build material at least hinders the advance of the body.

The position of the surface of the build material may be determined at 550, based at least on the advance of the belt element that has been measured.

The amount of build material in the build material container may be derived from the determined position of the surface of the build material and the dimensions of the build material container.

FIG. 2 illustrates implementations of a system 100 as disclosed herein for measuring the amount of build material 210, such as for example build powder, in a build material container 200 of a 3D printer.

With reference to FIG. 2, implementations of a system 100 for measuring the amount of build material may comprise a belt element 110 to be mounted under a tension, as shown by arrow T, between at least two shafts 120 and 130, and extending at least partly inside the material container 200. A body 140 may be attached to the belt element 110, for example in a position between the shafts 120 and 130 as shown in FIG. 2, such that the body 140 is also inside the build material container 200.

The body 140 may move up and down inside the container driven by a movement of the belt element 110. In some implementations the shafts 120 and 130 may be pulleys or the like, and the belt element 110 may be an endless belt element, mounted in close loop (not shown in FIG. 2) between the shafts 120 and 130. In some other implementations the shafts may be drums or the like, and opposite ends of the belt element 110 may be wound around each of the shafts 120 and 130.

The system 100 may comprise a motor 150, to advance the belt element 110 and the body 140 towards a surface 220 of the build material 210 that is inside the build material container 200, and a sensor 160 to detect the advance of the belt element 110.

In some implementations the motor may cause the advance of the belt element 110 by driving in rotation one of the shafts, for example shaft 120 as schematically shown in FIG. 2. In implementations wherein the belt element 110 is not mounted in closed loop, a tensioner (not shown) may be provided. For example, one of the shafts may be spring-loaded. For example, one of the shafts may be a drum driven by the motor, and the other shaft may be a drum loaded with a torsion spring or with another suitable kind of tensioner.

In some implementations the sensor 160 may comprise an encoder, and it may detect the advance of the belt element 110 by detecting the rotation of the motor 150, for example of the motor axis (not shown). However, other solutions are also possible: for example, in some implementations an encoder or other kind of sensor 160 may detect the advance of the belt element 100 directly by readings of the belt element 110, which in this case may be provided with visible marks or other elements detectable by the sensor 160.

In implementations as shown in FIG. 2, the output of the sensor 160 may be supplied to a controller 170, which is to receive the data from the sensor 160 and use this data to measure or monitor the advance and the speed of the belt element 110.

When the speed of the belt element 110 decreases, the controller 170 may determine that the body 140 has contacted the surface 220 of the build material 210, since the contact with the build material 210 hinders or prevents the advance of the body 140 and of the belt element 110 to which the body 140 is attached.

The controller 170 may also control the operation of the motor 150.

Implementations of a method for measuring the amount of build material in a build material container of a 3D printer, such as disclosed above, may be carried out with a system such as illustrated by FIG. 2.

Implementations of the method and system disclosed herein allow providing robust and reliable measures of the amount of build material present in a build material container, even in the difficult conditions that may be found inside the container itself, which is an environment subject for example to large amounts of dust, to movements and vibrations, and to electrostatic charges.

The system relies on the tension of the belt element, and on the determination that the body has reached the build material surface when the belt element reduces its speed. The body may be advanced together with the belt element until it safely contacts the surface of the build material, and the risk of errors in the readings due to the body being deflected or blocked by irregularly accumulated build material, or by friction, may be reduced by virtue of the belt element being mounted under tension between at least two shafts. A relatively light weight body may be employed, since the system is not based on gravity for the advance of the body. For the same reason, the weight of the belt element is not relevant for the advance of the body, and therefore the belt element may be designed as convenient to avoid friction issues, to be placed in a suitable position in the container, etc.

Implementations of the system and method may operate with different build materials, container sizes or geometry, and build material distributions within the build material container.

The mounting of the belt element tensioned between at least two shafts may allow flattening or stabilizing the build material surface before a measure is taken, for example by exerting a force on the surface, as disclosed later on, so accuracy in the measures may be increased.

FIGS. 3a and 3b illustrate examples of systems for measuring the amount of build material according to some implementations of a system as disclosed above: FIG. 3a shows a front view of the system 100, while FIG. 3b shows a side view of the system 100. Some of the elements of the system 100 have been omitted from FIG. 3b for clarity reasons.

As shown in FIGS. 3a and 3b, in a simple implementation such a system 100 for measuring the amount of build material may comprise two pulleys forming shafts 120 and 130, for example with one of the pulleys 130 mounted beneath the bottom 230 of the build material container 200, and the other pulley mounted inside the container 200 and attached to the top 240 of the container 200. The belt element 110 may be mounted in closed loop around the two pulleys, as visible in the view of FIG. 3b, and pass through the bottom 230 of the container 200 through suitable openings, which are not shown in the schematic diagrams.

The motor 150 may be mounted inside the container 200 to drive pulley 120, and the sensor 160 may be an encoder integrated to detect the rotation of the motor axis. The controller 170 may receive the signals from the sensor 160, in order to determine when the body 140 reaches the surface 220, and the position of the surface 220, as described above. The controller 170 and may also control the operation of the motor 150.

In some implementations, in a system such as shown in FIGS. 3a and 3b the motor 150 and sensor 160 may be outside the container 200: for example the motor 150 may be associated with the pulley 130, or the motor 150 may drive the pulley 120 through an axis passing through an opening in the container wall (not shown in FIGS. 3a and 3b).

In implementations of a system as disclosed herein, the body 140 may comprise a conical portion 142. For example, the outer surface of the body 140 may be substantially conical, as shown by way of example in FIG. 4.

A conical portion 142 reduces the risk that the body 140 may become buried and trapped in the build material, for example if build material is supplied to the container and falls on the body 140, because the conical portion 142 facilitates the extraction of the body upwards from the build material. Other outer shapes of the body 140 are possible, for example other shapes that are relatively narrow at the top and widen downwards (with the body in the use position), such as pyramidal shapes or truncated cone or pyramid shapes.

FIG. 5 illustrates examples of a body 140 that may be used in some implementations, in a view in cross section taken along a vertical diametrical plane. The body 140 may comprise a conical portion 142 on the outside, and a flat base 144 encircled by a projecting circumferential rim portion 145, such that the flat base 144 is recessed within the rim portion 145.

The recessed space formed between the flat base 144 and the rim 145 in the lower part of the body 140 of FIG. 5 becomes filled with build material when the body contacts the build material surface, and this helps stabilizing the position of the body on the surface because the trapped build material may not escape so easily outwards from under the body 140.

In some implementations of the system, the body 140 may comprise a grid 146, intended to contact the build material and allow the body to settle in a stable and reliable way on the surface of the build material. FIG. 6 schematically shows in perspective an example of a body 140 with such a grid 146, which may for example comprise a number of bars 147 and a circumferential rim 148.

However, the grid may be constructed in other suitable ways, such as for example with bars of different geometry and arranged in different patterns, or perforated plates, or meshes or the like, or a combination thereof. It may have any suitable peripheral shape and any suitable dimension. In some implementations the grid 146 may be attached to a conical portion 142 to form a base portion or sole portion of the body 140, as shown in FIG. 6.

The belt element 110 may be, in some implementations, an endless belt element, mounted in closed loop between two or more shafts, as shown by way of example in FIGS. 3a and 3b above. However, in some implementations a belt element 110 may also be mounted in open loop, for example it may extend tensioned between two shafts, such as two drums or the like.

In some implementations a belt element 110 as used herein may be for example a flat belt, V belt, multi-groove belt, or other, which may be for example of an elastomeric material, with or without reinforcements. However, in some implementations the belt element may also have other suitable shapes and comprise other suitable materials. For example it may have the shape of a cord or cable. The belt element may be for example a metallic or polymeric cable of round section, a multifilament cable, or other.

The shafts 120, 130, and/or any other shafts around which the belt element 110 is to be mounted, may have shapes that are suitable for the shape and material of the belt element 110 selected for each implementation.

In order to improve the reliability of the measures of the advance of the belt element, according to some implementations the belt element 110 and at least one of the shafts 120, 130, and/or others if present, may comprise an anti-slippage system which may prevent or reduce slippage between the belt element and the shafts.

Examples of anti-slippage systems that may be employed in some implementations may comprise coatings provided e.g. on a shaft to increase the friction with the belt element, for example in the case of a metallic belt element, or they may comprise winding the belt element around the shafts by more than one turn.

Slippage may also be reduced or avoided by providing a toothed belt element and at least one matching toothed shaft, or by employing a chain as a belt element and sprockets by way of shafts, in order to provide a positive drive between the belt element and the shaft.

Implementations of systems for measuring an amount of build material as disclosed above may be employed in a build material container in a 3D printer, in order to measure and monitor the amount of build material present in the container during the 3D printer operation and/or between jobs. In some implementations, this may allow issuing a warning or preventing a new job from being started if the measured amount of build material is low: for example, if it is below a predetermined threshold, or if it is determined that it is not sufficient to complete the following job.

FIG. 7 illustrates implementations of a build material container 200 of a 3D printing apparatus as disclosed herein, which may comprise a build material space 205 to contain build material 210, and a system for measuring the amount of build material in the container 200.

In some implementations, the system for measuring the amount of build material comprises a belt element 110, mounted tensioned, as shown by arrow T, between at least two shafts 120 and 130, and extending through the build material space 205, to which a body 140 is attached so as to be displaced together with the belt element 110. The system 100 may comprise, as shown, a motor 150 to drive the belt element, a sensor 160 to detect the advance of the belt element 110, for example by readings of the rotation of the motor 150, and a controller 170.

The controller 170 may control the operation of the motor 150 to drive the belt element 110 and the body 140 towards the build material surface 220, and it may receive data of the advance of the belt element 110 from the sensor 160. With this data the controller 170 may measure or monitor the advance and the speed of the belt element 110 during the movement.

The controller 170 may determine that when the speed of the belt element 110 decreases, the body 140 has contacted a surface 220 of the build material 210.

A decrease in speed of the belt element may be detected by the controller 170 by detecting from the readings of the sensor 160 that the speed of an output shaft (not shown) of the motor 150 is below a predetermined threshold, which may be set for example by performing a calibration of the system. In some implementations, the controller 170 may determine that the body 140 has contacted the surface 220 of the build material 210 when the readings of the sensor 160 show that the speed of the output shaft of the motor 150 is zero.

The controller 170 may then determine the position of the surface 220 of the build material 210, based at least on the measured advance of the belt element 110. In some implementations, the controller 170 may also determine the amount of build material 210 present in the container 200, based on the position of the surface 220 and the geometry of the container 200.

In implementations in which the controller 170 controls the motor 150, the controller may also de-energize the motor 150.

A build material container 200 may comprise implementations of a system for measuring the amount of build material according to the present disclosure, for example it may comprise any of the systems disclosed above in relation with FIGS. 2 to 6.

As shown in FIG. 7, in implementations disclosed herein the build material container 200 may comprise, above the space 205, a build platform 250, on which an object is generated in successive layers, and the shaft 120 of the system for measuring the amount of build material may be attached to the underside of the build platform 250. The motor 150 may drive the shaft 120, as shown in FIG. 7, and it may be also attached to the build platform 250. However, it may also be positioned to drive the shaft 130 instead of the shaft 120, or to drive another shaft of the system if the belt element 110 is mounted around additional shafts. The motor 150 may be mounted outside the container 200.

In some implementations, the build platform 250 is movable in vertical direction, as shown by arrow A in FIG. 7, and may descend a certain distance after completion of each layer of the object that is being generated, before the next layer of build material is spread on the build platform 250.

In such a case, the system for measuring the amount of build material may comprise in some implementations a belt tensioner, such as very schematically indicated at 112, to maintain the tension of the belt element 110 when the build platform 250 is displaced and the distance between shafts 120 and 130 changes.

A belt tensioner 112 may comprise in some implementations one or more additional shafts, for example displaceable and loaded with a spring, to displace a length of belt element 110 horizontally within the space 205, or it may comprise for example a torsion spring associated with one of the shafts 120 or 130 if for example the shafts comprise drums and the belt element 110 is mounted with each end wound around one of the drums. Other suitable solutions may also be provided.

In some implementations of a build material container 200 for a 3D printer with a displaceable build platform 250, the system for measuring the amount of build material may comprise additional shafts that are positioned to mount the belt element 110 around them in such a way that it extends partly inside the container 200, in the space 205, and partly outside the container 200, and in such a way that the length of the belt element 110 may remain substantially constant when the build platform 250 is displaced.

For example, some implementations of a build material container 200 are illustrated in FIGS. 8a and 8b, which schematically show a build material container 200 in two different positions of an operation for the manufacture of a 3D object 300. In FIG. 8a the build platform 250 is at one level with respect to the base of the container 200. After a layer of the object 300 that is being generated on the build platform 250 is completed, the build platform may descend, as shown by arrow B. in FIG. 8b the build platform 250 is shown at a lower level, and some additional layers of the object 300 have been formed on the build platform 250. As shown in FIGS. 8a and 8b, the build platform 250 has descended a distance D between the two positions. The amount of build material 210 in the container 200 may have decreased, since some build material 210 has been employed to form layers of the object 300.

In some implementations the build material container 200 with build platform 250 may be provided on a trolley or building unit that may be docked in a 3D printer and withdrawn for loading and unloading operations.

In some implementations, the system for measuring the amount of build material may comprise the belt element 110, the shaft 120 attached to the platform 250, and the shaft 130 attached below the base of the container 200, and it may comprise additional shafts 122, 124, 126 and 128, around which the belt element 110 is mounted in closed loop for example as shown in FIGS. 8a and 8b.

In implementations such as shown in FIGS. 8a and 8b the belt element 110 may be mounted to extend between shafts 120, 122, 124, 126, 128, 130 and then back to shaft 120. Additional shafts 122, 126 and 128 may be attached like shaft 120 to the underside of the build platform 250, inside the space 205, while shaft 124 may be attached outside the build material container 200, for example on an outer wall of the container 200, at the top thereof. The additional shaft 124 may be mounted for example at the higher level reached by the build platform 250.

A suitable vertical groove (not shown) may be provided in the wall of the build material container 200 so that the belt element 110 may pass therethrough.

In the passage between the positions of FIGS. 8a and 8b, when the build platform 250 has descended a distance D, the distance between shafts 120 and 130 is reduced of a distance D. However, by virtue of the mounting of the belt element 110 around the additional shafts 122, 124, 126 and 128, the reduction in the distance between shafts 120 and 130 is compensated by an increase in the distance between shaft 124 and shafts 122 and 126, such that the length of the belt element 110 may remain substantially constant when the build platform 250 is displaced.

The motor 150, sensor 160 and controller 170 have been omitted from FIGS. 8a and 8b for clarity reasons. The motor 150 may be mounted to drive shafts 120 or 130, as disclosed above, but for example in implementations such as that of FIGS. 8a and 8b where there is a shaft 124 mounted outside the build material container 200, such as shaft 124, the motor 150 may also be positioned on the outside of the container, for example to drive this shaft 124. The sensor 160 and/or the controller 170 may also be placed outside the container.

In implementations comprising a system for measuring the amount of build material as disclosed in relation to FIGS. 8a and 8b, the determination of the position of the surface 220 of the build material 210 may take into account the measured advance of the body 140 and also the position of the build platform 250 at the time the measure of the amount of build material is made. For example, the controller 170 may obtain data on the position of the build platform 250, to be used in the determination of the position of the build material surface 220. Implementations of a method as disclosed herein for measuring the amount of build material in the build material container are generally carried out when the build platform 250 is not moving. For example, the amount of build material may be measured as disclosed above when the build platform 250 is in the position of FIG. 8a. Subsequently, the amount of build material may be again measured as disclosed above at a later stage in the object manufacturing process, for example when the build platform 250 is in the position of FIG. 8b.

Some implementations of a method as disclosed above in relation to FIG. 1 may comprise compacting the build material, as illustrated in FIG. 9, where parts common with FIG. 1 have the same reference numerals. For example, as shown in FIG. 9, a method for measuring the amount of build material in a build material container may comprise, after determining that the body has reached the surface at 540, and before determining the position of the surface at 550, performing at 545 a build material compacting operation, for example on the surface of the build material.

The build material compacting operation at 545 may comprise in some implementations lifting the body from the surface of build material and driving it back towards the surface of the build material, such as illustrated by the schematic view of FIG. 10, wherein the arrows E, F show the operations of lifting the body 140 (arrow E) and driving it back towards the surface 220 of the build material 210 (arrow F).

Implementations of the method involving a compacting operation may provide more accurate and consistent determinations of the position of the surface 220 of the build material 210, and therefore of the amount of build material 210 present in the build material container 200.

An example method according to implementations disclosed in relation with FIGS. 9 and 10 may be performed with systems for measuring the amount of build material such as disclosed above in relation with FIGS. 2 to 7, for example with a body 140 such as in one of the examples of FIGS. 4 to 6. In implementations of the systems, after the controller 170 has determined that the body 140 has contacted the surface 220, the controller 170 may operate the motor 150 to reverse and drive the belt element 110 and body 140 upwards (arrow E in FIG. 10) a predetermined distance and/or during a predetermined time, and then again drive the belt element 110 and body 140 downwards towards the surface of the build material (arrow F in FIG. 10) until a decrease in the speed is again determined by the controller 170, showing that the body 140 has again reached the surface 220.

In some implementations a compacting operation may be performed once, or a predetermined number of times, or it may be repeated until for example the decrease in speed when the body 140 reaches the surface 220, determined by the controller 170, is substantially the same before and after a compacting operation.

In other implementations it is possible to perform several compacting operations and determine the position of the surface 220 of the build material 210 after each, until the surface of the material becomes stabilized. For example, the surface may be considered stabilized when the position of the surface 220 determined by the controller 170 before and after a compacting operation is substantially the same.

At the end of a compacting operation the controller 170 may determine the position of the surface of the build material, by taking into account the subsequent advances of the belt element 110 and the body 140 in both directions (arrows E and F in FIG. 10).

Although a number of particular implementations and examples have been disclosed herein, further variants and modifications of the disclosed devices and methods are possible. For example, not all the features disclosed herein are included in all the implementations, and implementations comprising other combinations of the features described are also possible.

1. A method for measuring the amount of build material in a build material container of a 3D printer, comprising:
mounting a belt element tensioned between at least two shafts, and attaching a body to the belt element;
driving the body attached to the belt element towards a surface of the build material while measuring the advance and the speed of the belt element,
detecting a reduction of the speed of the belt element,
determining that when the reduction of the speed is detected, the body has contacted the surface of the build material, and
determining the position of the surface of the build material based at least on the measured advance of the belt element.

2. A method as claimed in claim 1, comprising performing a build material compacting operation after detecting the reduction of the speed and before determining the position of the surface.

3. A method as claimed in claim 2, wherein the build material compacting operation comprises lifting the body from the surface of build material and driving it back towards the surface of the build material.

4. A system for measuring the amount of build material in a build material container of a 3D printer, comprising
a belt element to be mounted tensioned between at least two shafts and extending at least partly inside the material container,
a body, attached to the belt element, to be placed inside the material container,
a motor to advance the belt element and the body towards a surface of the build material in the build material container,
a sensor to detect the advance of the belt element, and
a controller to receive data from the sensor and measure the speed of the belt element, and to determine that when the speed of the belt element decreases the body has contacted the surface of the build material.

5. A system as claimed in claim 4, wherein the body comprises a conical portion.

6. A system as claimed in claim 5, wherein the body comprises a flat base encircled by a projecting circumferential rim portion, such that the flat base is recessed within the rim portion.

7. A system as claimed in claim 4, wherein the body comprises a grid sole to contact the surface of the build material.

8. A system as claimed in claim 4, wherein the belt element is an endless belt element, mounted in closed loop between the at least two shafts.

9. A system as claimed in claim 4, wherein the sensor to detect the advance of the belt element comprises an encoder.

10. A system as claimed in claim 4, comprising an anti-slippage system associated with the belt element and/or at least one of the shafts, whereby slippage between the belt element and at least one shaft is avoided.

11. A build material container for a 3D printer, comprising a build material space to contain build material, and a system for measuring the amount of build material,
wherein the system for measuring the amount of build material comprises
a belt element mounted tensioned between at least two shafts and extending through the build material space,
a body, attached to the belt element,
a motor to drive the belt element,
a sensor to detect the advance of the belt element, and
a controller to receive data of the advance of the belt element from the sensor and measure the advance and the speed of the belt element, to determine that when the speed of the belt element decreases the body has contacted a surface of the build material, and to determine the position of the surface of the build material based at least on the measured advance of the belt element.

12. A container as claimed in claim 11, comprising a build platform on which an object may be generated by spreading and selectively solidifying layers of build material, wherein the shafts between which the belt element is mounted comprise a pulley attached to a base of the build material container and a pulley attached to the build platform.

13. A container as claimed in claim 12, wherein the build platform is displaceable with respect to the base of the build material container, and the system for measuring the amount of build material comprises a belt tensioner to maintain the belt element under tension when the build platform is displaced.

14. A container as claimed in claim 12, wherein the build platform is displaceable with respect to the base of the build material container, and the system for measuring the amount of build material comprises additional shafts to mount the belt element extending partly inside the container and partly outside the container, in such a way that the length of the belt element remains substantially constant when the build platform is displaced.

15. A container as claimed in claim 14, wherein the motor to advance the belt element and the sensor to detect the advance of the belt element are mounted on the outside of the container.
